(19) United States
(12) Patent Application Publication
(10) Pub. No.: US 2015/0040670 A1
(43) Pub. Date: Feb. 12, 2015

(54) Inertial Sensor Module

(71) Applicant: Hitachi Automotive Systems, Ltd., Hitachinaka-shi, Ibaraki (JP)

(72) Inventors: Kiyoko Yamanaka, Tokyo (JP); Heewon Jeong, Tokyo (JP); Masahide Hayashi, Tokyo (JP)

(21) Appl. No.: 14/381,827

(22) PCT Filed: Jan. 25, 2013
(86) PCT No.: PCT/JP2013/051519

§ 371 Date: Aug. 28, 2014

(30) Foreign Application Priority Data
Mar. 30, 2012 (JP) 2012-078877

(51) Int. Cl. G01P 15/08

(52) U.S. Cl. CPC G01P 15/0802
USPC 73/514.35

(57) ABSTRACT

In a sensor module capable of changing a detection axis to detect a physical quantity, when a pad is provided at a location other than a corner point of an LSI-side, for the purpose of solving problems such as an increase in a chip surface area and an increase in development costs, caused by guide wiring for connecting the pad, the inertial sensor module is provided with: a first sensor element (100) having a first pad group (120), a second pad group (130) electrically connected to the first pad group and disposed at a location rotated 90 degrees with respect to the first pad group, and a detection axis; and an LSI (202) which controls the first sensor element. In the inertial sensor module, the first sensor element is disposed along a first side of the LSI, a plurality of third pad groups (203) is disposed along a second side intersecting the first side of the LSI, and the third pad group is electrically connected to either the first pad group or the second pad group.

### TECHNICAL FIELD

The present invention relates to an inertial sensor module. The invention particularly relates to an inertial sensor module to detect a physical quantity which is attributable to an inertial force acting on a body and has a detection axis.

### BACKGROUND ART

With computerization of vehicle control, the number of inertial sensor modules equipped in vehicles to detect a vehicle motion has been increasing. For example, among inertial sensor modules, an angular velocity sensor module in particular has conventionally been applied mainly for the purpose of measuring a vehicle yaw rate which is used in a traveling control system to automatically control a brake or an engine when detecting a dangerous traveling of a vehicle. In addition, recently, there has been a growing demand for an angular velocity sensor applied to measurement of a roll rate which is used in a traveling safety system to activate an occupant restraint device when detecting rolling of a vehicle.

To meet such a growing demand, it is conceivable that an inertial sensor module is developed and supplied separately for each different application purpose. However, from the aspect of development period and costs, it is preferable to develop a single inertial sensor module so as to adapt a plurality of application purposes. Specifically, it is preferable to make a single kind of inertial sensor module adaptable to a plurality of application purposes such as both of the aforementioned traveling control system and traveling safety system.

The problem is that a yaw rate is an angular velocity in a turning direction of a vehicle body whereas a roll rate is an angular velocity in a rolling direction of a vehicle body. In other words, a detection axis is different between a yaw rate and a roll rate, although they both are dynamic quantities determining rotational motions of a vehicle.

Here, in order to perform, using a single kind of inertial sensor module, a measurement of dynamic quantities having a plurality of detection axes, such as a measurement of both a yaw rate and a roll rate, an angle of attaching the inertial sensor module on an electronic control unit substrate may be changed, depending appropriately on what is to be measured. However, changing an angle of attaching an inertial sensor module on an electronic control unit substrate is accompanied with changing a mounting state of other components, which may make it impossible to change the angle as desired. Moreover, as a vehicle on which an electronic control unit substrate is mounted has a limited space for such substrate, an inertial sensor module may not be able to be attached in a desired angle. Besides, although an angular velocity has been particularly described thus far as an example of a physical quantity, the same discussion as above applies to a different physical quantity having a detection axis, such as an acceleration.

In view of the foregoing, it is convenient and preferable that a detection axis of a physical quantity is selectable as appropriate without changing a mounting angle of an inertial sensor module. PTL 1 discloses a prior art in which a detection axis of a physical quantity is appropriately selectable in such a way as above. PTL 1 describes a technology to provide a plurality of pads having the same function on an LSI, when a dynamic quantity sensor element is arranged on an LSI, in order that wire-bonding wiring may be permitted even when the sensor element is disposed in a rotated manner by 0, 45, and 90 degrees. According to the technology described in PTL 1, the sensor element is able to be mounted selectively in a direction of 0, 45, and 90 degrees with respect to a reference edge portion on an LSI. Therefore, a sensor module having such a dynamic quantity sensor element on an LSI as described in this technology is able to select a direction of a dynamic quantity detection axis from 0, 45, and 90 degrees, without changing a mounting angle of the sensor module.

### CITATION LIST

### Patent Literature

PTL 1: JP 2000-227439 A

### SUMMARY OF INVENTION

### Technical Problem

A conventional technology disclosed in PTL 1 has a following possible problem. When a pad is provided on an LSI in such a manner that a sensor element is able to be mounted selectively in a direction of 0, 45, and 90 degrees with respect to a reference edge portion on an LSI, the pad is disposed other than at a corner point of the LSI. Generally, a pad disposed on an LSI is approximately 100 μm in dimension, which is large enough for a wiring width (1 μm or less in general) of a logic section in an LSI. When such a large pad is disposed in a specific area on an LSI, guide wiring to conduct a computed signal to the pad intersects a computing function block, which makes it difficult to effectively use an LSI area. This could result in an increased chip surface area leading to increased development costs.

### Solution to Problem

To solve such problem as described above, a configuration disclosed in Claims is adopted as an example.

That is, provided is an inertial sensor module including: a first sensor element having a detection axis, including: a first pad group; and a second pad group electrically connected to the first pad group and disposed at a location rotated 90 degrees with respect to the first pad group; and n LSI configured to control the first sensor element, herein the first sensor element is disposed along a first side of the LSI, the LSI has a plurality of third pad groups disposed along a second side of the LSI, the second side intersecting the first side, and the third pad group is electrically connected to either the first pad group or the second pad group.

### Advantageous Effects of Invention

According to the present invention, it is possible to provide an inertial sensor module adaptable to two or more detection axes in a smaller area or at lower cost. Other problems, configurations, and effects will be clearly described in the description of embodiments given below.

### BRIEF DESCRIPTION OF DRAWINGS

FIG. 1 is a top view showing an angular velocity sensor element in Example 1 of the present invention.

FIG. 2 is a sectional view showing the angular velocity sensor element in Example 1 of the present invention.

Each of FIGS. 3(a) and 3(b) is a top view showing an angular velocity sensor module in Example 1 of the present invention.

FIG. 4 is a sectional view showing the angular velocity sensor module in Example 1 of the present invention.

FIG. 5 is a top view showing an angular velocity sensor element in Example 2 of the present invention.

FIG. 6 is a sectional view showing the angular velocity sensor element in Example 2 of the present invention.

FIG. 7 is a top view showing an inertial sensor module in Example 3 of the present invention.

FIG. 8 is a top view showing the inertial sensor module in Example 3 of the present invention.

FIG. 9 is a sectional view showing the inertial sensor module in Example 3 of the present invention.

### DESCRIPTION OF EMBODIMENTS

Examples are described below with reference to the drawings.

### Example 1

Example 1 provides a description of an angular velocity sensor module in which an angular velocity sensor element is mounted, as an exemplary inertial sensor module applying the present invention.

### (Top View of Sensor Element)

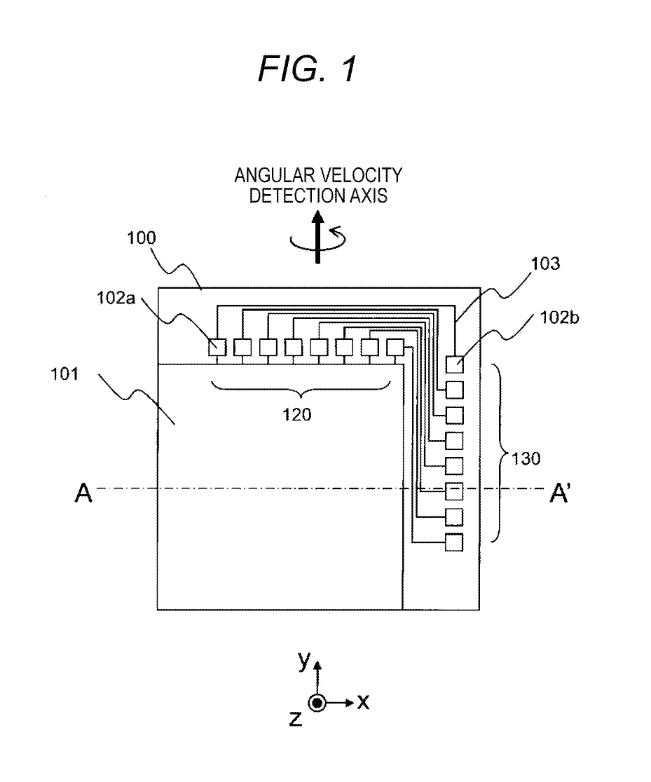

FIG. 1 is a top view showing an angular velocity sensor element in Example 1. The sensor element 100 includes: a support substrate; a cap 101 to hermetically protect a space in which a MEMS structure is provided; wiring 103 for leading an electrical signal to control motion of the MEMS structure and an electrical signal generated from motion of the MEMS structure; and pad groups 120, 130 to input/output such electrical signals. The MEMS structure is provided inside the cap 101 and is not shown in FIG. 1. The MEMS structure is, for example, a structure formed by using a photolithography technique and a deep reactive ion etching (DRIE) technique.

Here, in the sensor element in FIG. 1, a pad included in the pad group 120 and a pad included in the pad group 130 are electrically connected to each other. For example, a pad 102a included in the pad group 120 and a pad 102b included in the pad group 130 are connected by the wiring 103, so that the pads are in an equipotential state. Therefore, it is possible to extract, from either the pad 102a or the pad 102b, an electrical signal generated from motion of the same MEMS structure. Alternatively, it is possible to drive the sensor element by giving an electrical signal, to either the pad 102a or the pad 102b, to control motion of the same MEMS structure. Here, wiring in the sensor element in FIG. 1 is formed in a single wiring layer. With this feature, the sensor element in FIG. 1 is effective in that it requires a less number of forming processes of wiring, and hence is produced at low cost.

The sensor element is capable of receiving/transmitting all input/output signals from/to an outside computation circuit through the pad group 120 having eight pads. However, in the present example, the pad group 130 having eight pads is also disposed on the sensor element, in such a manner that the pad group 130 is disposed along a different side of the sensor element from a side along which the pad group 120 is disposed. Each pad belonging to the pad group 130 is electrically connected by wiring individually to each pad belonging to the pad group 120, so that corresponding pads are in an equipotential state. Therefore, it is possible to extract, from either a pad belonging to the pad group 130 or a pad belonging to the pad group 120, an electrical signal generated from motion of the same MEMS structure. Alternatively, it is possible to drive the sensor element by giving an electrical signal, to either a pad belonging to the pad group 130 or a pad belonging to the pad group 120, to control motion of the same MEMS structure. In FIG. 1, a detection axis with respect to which the sensor element detects an angular velocity is indicated by an arrow.

In the present example, a pad arrangement of the pad group 120 and a pad arrangement of the pad group 130 are identical so that such configuration enables the both pad groups to input/output the same electrical signal. However, arrangements of the pad groups are not limited to a case where the arrangements are completely identical in terms of corresponding individual pads. There is a possible variation in which a set of pads performing a function in pairs is regarded as a unit and arrangements of the pad groups are identical in terms of corresponding sets of pads. An example of the variation will be described later in Example 2.

### (Sectional View of Sensor Element)

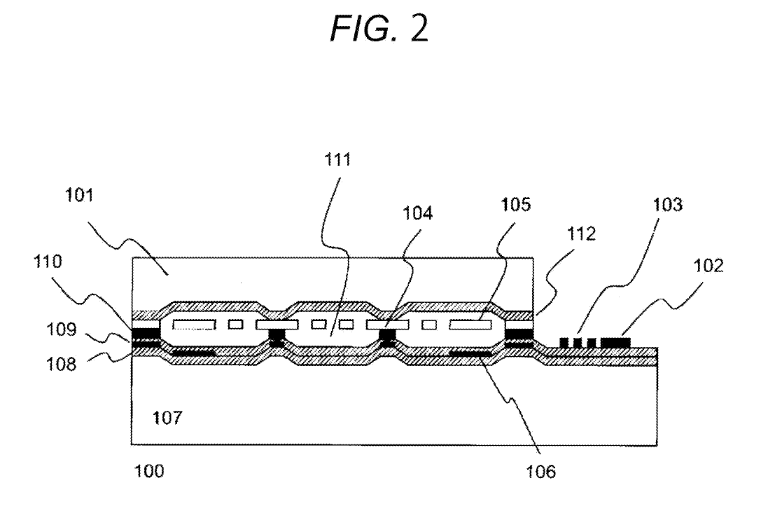

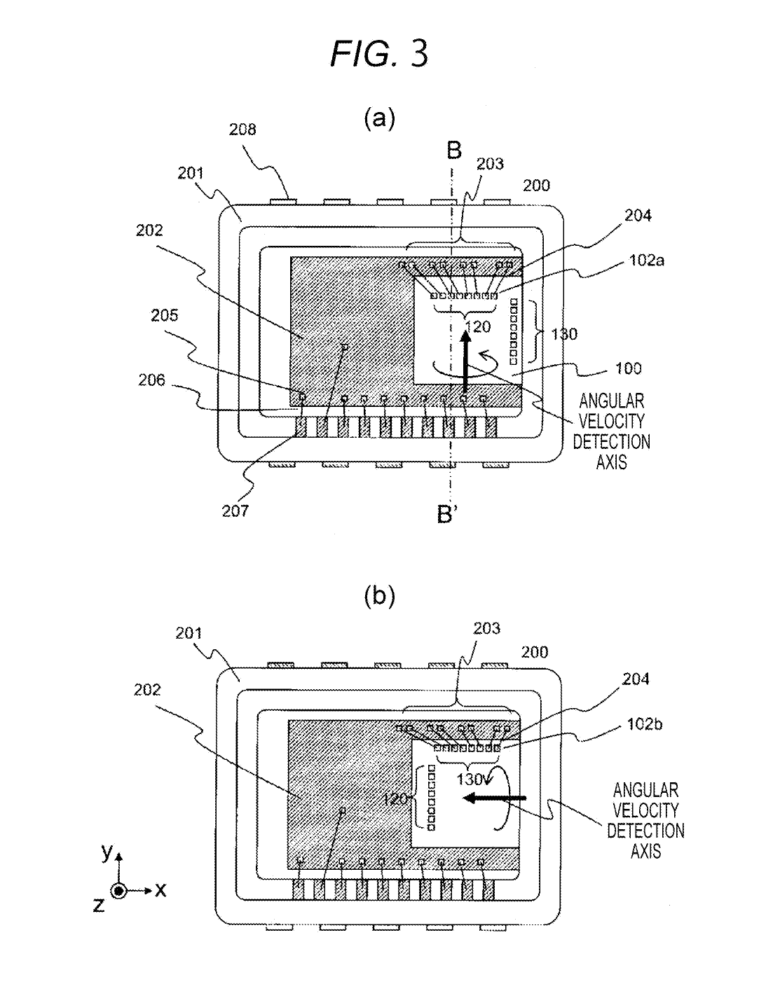

FIG. 2 is a sectional view showing the detail of the sensor element 100 in the angular velocity sensor module in Example 1. A MEMS structure to detect an angular velocity is formed in the sensor element 100. FIG. 2 is a sectional view of the sensor element 100 taken along the line A-A′ shown in FIG. 1. The sensor element 100 includes: a support substrate 107 on or above which are formed an insulation film 108, a metal film 106 forming a detection electrode, and an insulation film 109; and a cap substrate 101 under or below which are formed an insulation film 112, a movable part 105 of the MEMS structure, and a fixing part 104 of the MEMS structure. The sensor element 100 is formed by bonding the support substrate 107 and the cap substrate 101 together via an adhesive layer 110. The support substrate 107 and the cap substrate 101 are joined by eutectic bonding, so that an internal space 111 in which the MEMS structure is disposed is hermetically protected.

Furthermore, the movable part 105 of the MEMS structure, the detection electrode formed of the fixed metal film 106, and the fixing part 104 of the MEMS structure are electrically connected to a pad 102 formed on a surface of the support substrate 107, interposing a metal film 106 formed above the support substrate 107, and further connected via the pad 102, by wire bonding, to an integrated circuit having a function of computing an output signal from an angular velocity sensor detection section.

### (Top View of Sensor Module 1)

FIG. 3(a) is a top view showing an exemplary mounting configuration of the angular velocity sensor module 200 in Example 1.

A computation circuit chip 202 is mounted on a bottom portion of a package member 201. The sensor element 100 is mounted on the computation circuit chip 202. The integrated circuit including a transistor and a passive element is formed on the computation circuit chip 202. The integrated circuit is a circuit for signal-processing an output signal from the angular velocity sensor detection section, to finally output an angular velocity signal. The pad group 120 formed on the sensor element 100 and a pad group 203 formed on the computation circuit chip 202 are connected by a metal wire 204. A pad group 205 formed on the computation circuit chip 202 is connected to terminals 207 formed on the package member 201 by metal wires 206. Further, the pad group 205 is electrically connected, via internal wiring of the package member 201, to terminals 208 to be connected to the outside of the package member 201. Then, the computation circuit chip 202 and the sensor element 100 are hermetically enclosed in the package member 201 with a lid which is not shown but hermetically seals the package member 201 at the top portion thereof. A detection axis with respect to which the sensor element detects an angular velocity is in a Y(+) direction as shown in FIG. 3. Thus, the sensor module 200 with a mounting configuration shown in FIG. 3(a) is able to measure a rotation angular velocity around a Y axis.

### (Top View of Sensor Module 2)

FIG. 3(b) is a top view showing an exemplary mounting configuration of the angular velocity sensor module 200 in Example 1. The configuration is different from that shown in FIG. 3(a).

A sensor module in FIG. 3(b) is different from that in FIG. 3(a) in that the pad group 130 formed on the sensor element 100 and the pad group 203 formed on the computation circuit chip 202 are connected by the metal wire 204.

With the above difference in connection, in the sensor module in FIG. 3(b), a detection axis with respect to which the sensor element detects an angular velocity is in an X(−) direction as shown in FIG. 3. Thus, the sensor module 200 with a mounting configuration shown in FIG. 3(b) is able to measure a rotation angular velocity around an X axis.

As described above, a detection axis of the inertial sensor module is able to be changed by simply changing a mounting direction of the sensor element 100, while using entirely the same package member 201, computation circuit chip 202, and sensor element 100. In the present example, a sensor element in an angular velocity sensor has been described as an example. However, the same discussion as above applies to a different sensor having a detection axis (e.g., an acceleration sensor).

### (Sectional View of Sensor Module)

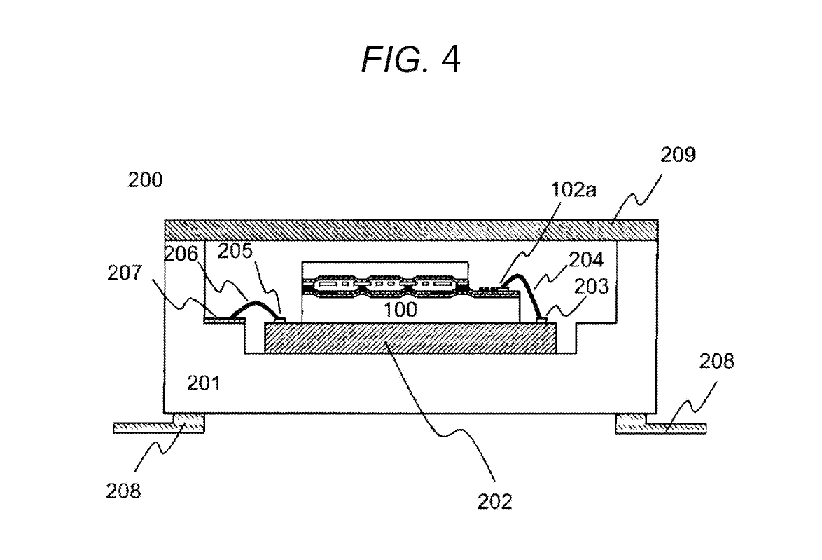

FIG. 4 is a sectional view showing an exemplary mounting configuration of the angular velocity sensor module 200 in Example 1. FIG. 4 is a sectional view of the angular velocity sensor module 200 taken along the line B-B′ shown in FIG. 3(a).

As shown in FIG. 4, the computation circuit chip 202 is mounted on a bottom portion of the package member 201 having a recessed portion. Also, the sensor element 100 is mounted on the computation circuit chip 202. The package member 201 is formed of ceramic and the like. Further, the computation circuit chip 202 and the sensor element 100 are hermetically enclosed in the package member 201 with a lid 209 which is made of metal and hermetically seals the package member 201 at the top portion thereof. The lid 209 is a metal cover used for hermetically sealing the package member 201 which houses the sensor element 100 and the computation circuit chip 202. The lid serves to prevent the package member 201 from foreign matter contamination.

As in the case of FIG. 3(a), when the pad group 120 is selected for use from the pad groups in the sensor element 100, the pad group 130, provided to detect an angular velocity output in regard to a detection axis which is not applied, is disconnected and left open. Meanwhile the unused pad group 130 is connected to the pad group 120 which is in use in the sensor element, via the wiring 103 located internally in the sensor element.

Here, a floating electric charge which exists outside the sensor element could adhere to a pad belonging to the open and unused pad group 130. This could have an adverse effect on a terminal of the in-use pad group 120, appearing as an output noise, through the metal film provided inside the sensor element. However, the package member 201 is hermetically sealed with the metal lid 209 which hermetically closes the package member 201 at the top portion thereof. Thus the sensor element 100 is protected from effects of a floating electric charge existing outside the sensor module. Therefore, the inertial sensor module in Example 1 enables the sensor element 100 to be shielded from and unaffected by a noise, even when the unused pad group 130 of the sensor element is disconnected and left open.

### (Configuration and Effects of Sensor Module)

Now a description is provided regarding a configuration and effects of the sensor module according to the present example. The inertial sensor module in the present example includes the first sensor element (100) and the LSI (202) which controls the first sensor element. The first sensor element (100) is provided with the first pad group (120) and the second pad group (130), and has a detection axis. The second pad group (130) is electrically connected to the first pad group and provided in a location rotated 90 degrees with respect to the first pad group. The first sensor element is situated along a first side of the LSI. The LSI has a plurality of third pad groups (203) situated along a second side of the LSI, the second side intersecting with the first side. The third pad group (203) is electrically connected to either the first pad group or the second pad group.

With the above configuration, it is possible to change a detection axis of the sensor element without modifying components other than the sensor element, as described with reference to FIGS. 3(a) and 3(b), by selecting either the first pad group or the second pad group as a pad group to be connected to the third pad group. Consequently, it is possible to provide an inertial sensor module capable of changing a detection axis, without changing a mounting angle of the inertial sensor module.

In addition, the sensor element is situated along the first side of the LSI, and the third pad group is situated along the second side of the LSI. This configuration makes it possible to avoid a problem caused by placing a pad which is larger in size compared to wiring width at a location other than a corner point of the LSI. Such problem has been discussed in reference to PTL 1. As a result, the above configuration achieves a reduced chip surface area and reduced development costs.

### Example 2

In Example 2, a sensor element 500 as a variant example of the sensor element 100 in Example 1 will be described.

### (Top View of Sensor Element)

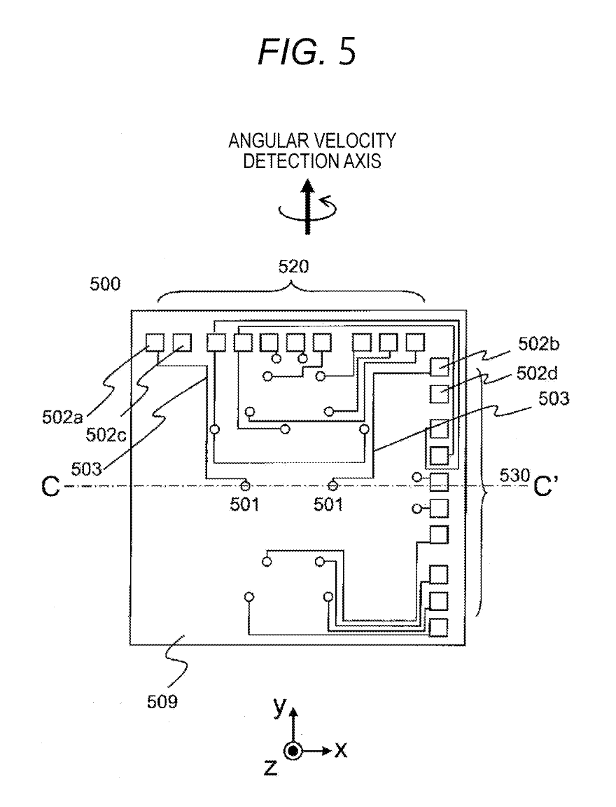

FIG. 5 is a top view showing an angular velocity sensor in Example 2. An insulation film 512 is not shown for convenience of drawing. The sensor element 500 includes: a support substrate; a cap substrate to hermetically protect a space in which a MEMS structure is disposed; wiring for leading an electrical signal to control motion of the MEMS structure and an electrical signal generated from motion of the MEMS structure; and pad groups 520, 530 to input/output the electrical signals.

In the sensor element in FIG. 5, a pad included in the pad group 520 and a pad included in the pad group 530 are electrically connected to each other. For example, a pad 502a included in the pad group 520 and a pad 502b included in the pad group 530 are electrically connected, interposing wiring 503 formed of a metal film, a substrate through part 501 formed of a conductive material, and the MEMS structure formed of a conductive material, so that the pads are in an equipotential state. Therefore, it is possible to extract, from either the pad 502a or the pad 502b, an electrical signal generated from motion of the same MEMS structure. Alternatively, it is possible to drive the sensor element by giving an electrical signal, to either the pad 502a or the pad 502b, to control motion of the same MEMS structure. Here, the wiring in the sensor element in FIG. 5 is, different from that in FIG. 1, formed in a plurality of wiring layers. With such feature, the sensor element in FIG. 5 has an increased flexibility in routing of wiring for electrically connecting a pad and a structure, enabling reduction of a parasitic resistance component and a parasitic capacitance component of the wiring. As a result, a sensor element with higher accuracy is able to be provided.

The sensor element is capable of receiving/transmitting all input/output signals from/to an outside computation circuit through the pad group 520 having ten pads. However, in the present example, the pad group 530 having ten pads is also disposed on the sensor element, in such a manner that the pad group 530 is disposed along a different side of the sensor element from a side along which the pad group 520 is disposed. Each pad belonging to the pad group 530 is electrically connected by wiring individually to each pad belonging to the pad group 520, so that corresponding pads are in an equipotential state. Therefore, it is possible to extract, from either a pad belonging to the pad group 530 or a pad belonging to the pad group 520, an electrical signal generated from motion of the same MEMS structure. Alternatively, it is possible to drive the sensor element by giving an electrical signal, to either a pad belonging to the pad group 530 or a pad belonging to the pad group 120, to control motion of the same MEMS structure. In FIG. 5, a detection axis with respect to which the sensor element detects an angular velocity is indicated by an arrow.

In the meantime, a pad arrangement in the sensor element in FIG. 5 is different from that in FIG. 1 in the following manner. In FIG. 5, arrangements of the pad groups (520, 530) are identical in regard to functional pairs of pads (paired 502a and 502c, and paired 502b and 502d). Here, a functional pair of pads means a pair of pads which performs a predetermined function as a unit. Arrangement order of such pair of pads is reversible. Take differential detection for example. In a detection electrode, a p-side electrode and an n-side electrode perform a differential detection function in pairs. Even when an arrangement order of the p-side electrode and the n-side electrode is reversed, the differential detection function is normally performed by reversing positive and negative of a detection signal in the computation circuit. Here, if the pad 502a is a p-side electrode and the pad 502c is an n-side electrode, the pad 502b and the pad 502d may be a p-side electrode and an n-side electrode, respectively, and vice versa. However, the arrangement of the pair of pads 502a-502c in the pad group 520 and the arrangement of the pair of pads 502b-502d in the pad group 530 are required to be identical. With the above configuration, the sensor element in FIG. 5 is effective in securing a flexibility in pad arranging and routing of wiring. Such flexibility is allowed to the extent that the different pad groups in the sensor element are able to input/output the same electrical signal, without impairing the effectiveness of the sensor element in FIG. 1.

In the present example, a variant example of the sensor element in Example 1 has been described. In the variant example, modifications of the sensor element in two aspects, i.e., wiring and pad arrangement, have been introduced. However, these modifications are able to be applied independently, and it is obvious that a sensor element in which only one of the modifications is applied belongs to the technical scope of the present invention.

### (Sectional View of Sensor Element)

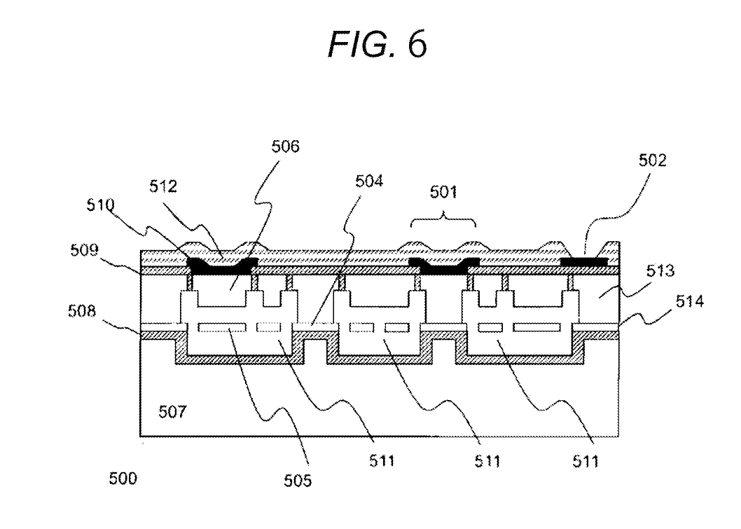

FIG. 6 is a sectional view showing the detail of the sensor element 500. FIG. 6 is a sectional view of the sensor element 500 taken along the line C-C′ shown in FIG. 5. In FIG. 6, for easier viewing of the drawing, a substrate through part 501, a pad 502, and a lower structure underlying them are shown in a magnified manner relative to those shown in FIG. 5.

The sensor element 500 is formed by bonding a support substrate 507, a device substrate 514, and a cap substrate 513 together. The support substrate 507, the device substrate 514, and the cap substrate 513 are joined by surface activation bonding or anodic bonding, so that an internal space 511 in which the MEMS structure is disposed is hermetically protected. The device substrate 514 and the cap substrate 513 are joined by surface activation bonding, and conductive materials which do not interpose an insulation film therebetween are mutually connected electrically.

A recessed groove is carved on the support substrate 507, in such a manner that an insulation film 508 and an internal space 111 are formed thereon. On the device substrate 514, there are formed a movable part 505 of the MEMS structure and a fixing part 504 of the MEMS structure. On the cap substrate 513, there are formed: a conductive material 506 to detect a motion of the MEMS structure; an insulation film 509; substrate through part wiring 501 which is formed of a conductive material to extract an electrical signal generated from motion of the MEMS structure; a metal film 510 to form the pad 502; and an insulation film 512 to protect the metal film 510. The movable part 505 of the MEMS structure, a detection electrode formed of the fixed conductive material 506, and the fixing part 504 of the MEMS structure are electrically connected to wiring formed on an upper surface of the cap substrate 513, and to the pad 502, via the substrate through part wiring 501 formed in the cap substrate 513. Via the pad 502, the movable part 505, the detection electrode, and the fixing part 504 are further connected, by wire bonding, to an integrated circuit which functions to operate an output signal from an angular velocity sensor detection section.

### Example 3

In Example 3, a sensor module as a variant example of the inertial sensor module 200 in Example 1 will be described. The sensor module in Example 3 detects a uniaxial rotation angular velocity and a triaxial acceleration.

### (Top View of Sensor Module 1)

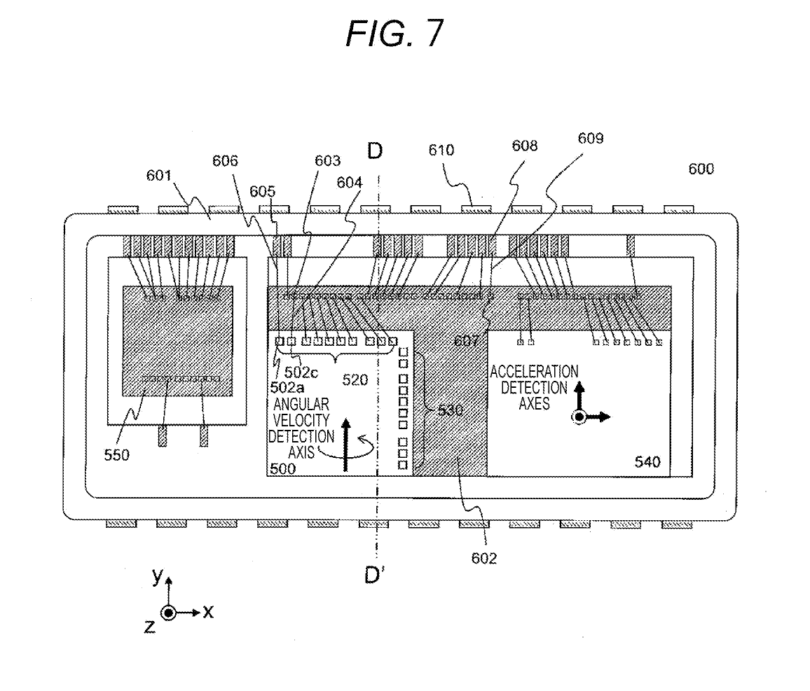

FIG. 7 is a top view showing an exemplary mounting configuration of the inertial sensor module 600 in Example 3.

In the inertial sensor module 600 according to the present example, a computation circuit chip 602 and a step-up power supply chip 550 are mounted on a bottom portion of a package member 601. On the computation circuit chip 602, there are mounted a sensor element 500 on which a MEMS structure to detect an angular velocity is formed and a sensor element 540 to detect an acceleration. Also on the computation circuit chip 602, an integrated circuit including a transistor and a passive element is formed. The integrated circuit formed on the computation circuit chip 602 is a circuit for signal-processing output signals from the sensor elements 500, 540, to finally output an angular velocity signal and an acceleration signal. An angular velocity sensor detection section is formed on the sensor element 500, and an acceleration sensor detection section is formed on the sensor element 540.

A pad group 520 formed on the sensor element 500 and a pad group 603 formed on the computation circuit chip 602 are connected with metal wire 604. For example, a pad 502c formed on the sensor element 500 and a pad 603 formed on the computation circuit chip 602 are connected with the metal wire 604. Further, a pad 502a formed on the sensor element 500 is connected, by metal wire 606, to a terminal 605 formed on the package member 601. Moreover, the pad 502a is electrically connected, via internal wiring of the package member 601, to a terminal to be 610 connected to the outside of the package member 601. Also, a pad group 607 formed on the computation circuit chip 602 is connected to, by metal wire 609, to a terminal 608 formed on the package member 601. The pad group 607 is electrically connected, via internal wiring of the package member 601, to the terminals 610 to be connected to the outside of the package member 601. Then the computation circuit chip 602, the step-up power supply chip 550, the sensor element 500, and the sensor element 540 are hermetically enclosed in the package member 601 with a cap which is not shown but hermetically seals the package member 601 at the top portion thereof. The sensor element 500 detects an angular velocity in a Y(+) direction as shown in FIG. 7. The sensor element 540 detects an acceleration in triaxial directions of X(+), Y(+), and Z(+), as shown in FIG. 7. Thus, the sensor module 600 with a mounting configuration shown in FIG. 7 is able to measure a rotation angular velocity around a Y axis, and an acceleration in triaxial directions along X, Y, and Z axes.

### (Top View of Sensor Module 2)

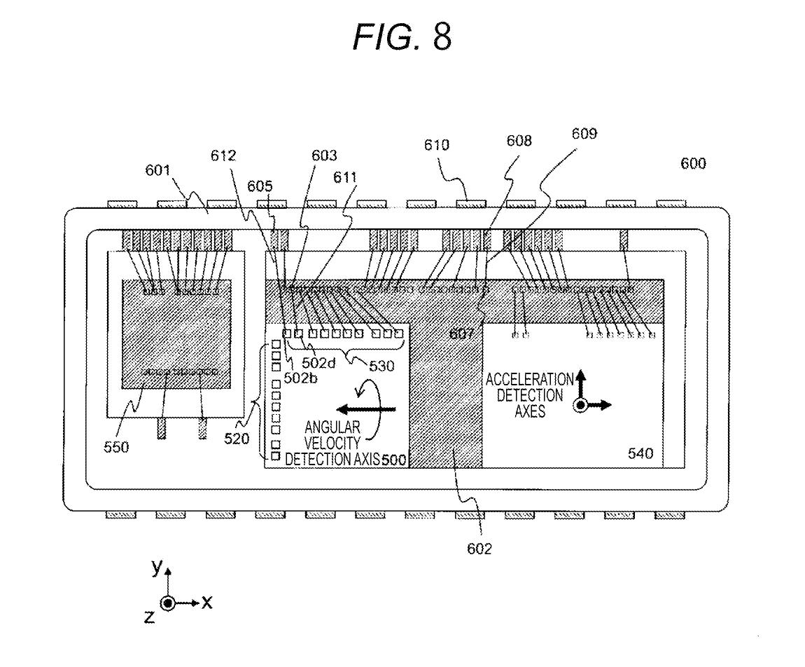

FIG. 8 is a top view showing an exemplary mounting configuration of the inertial sensor module 600 in Example 2. The configuration is different from that in FIG. 7.

The sensor module in FIG. 8 is different from the sensor module in FIG. 7 in that a pad group 530 formed on the sensor element 500 and the pad group 603 formed on the computation circuit chip 602 are connected by a metal wire 612. With the above difference in connection, the sensor element 500 detects an angular velocity in an X(−) direction as shown in FIG. 8. The sensor element 540 detects an acceleration in triaxial directions of X(+), Y(+), and Z(+), as shown in FIG. 8. Thus, the sensor module 600 with a mounting configuration shown in FIG. 8 is able to measure a rotation angular velocity around an X axis, and an acceleration in triaxial directions along X, Y, and Z axes.

### (Sectional View of Sensor Module)

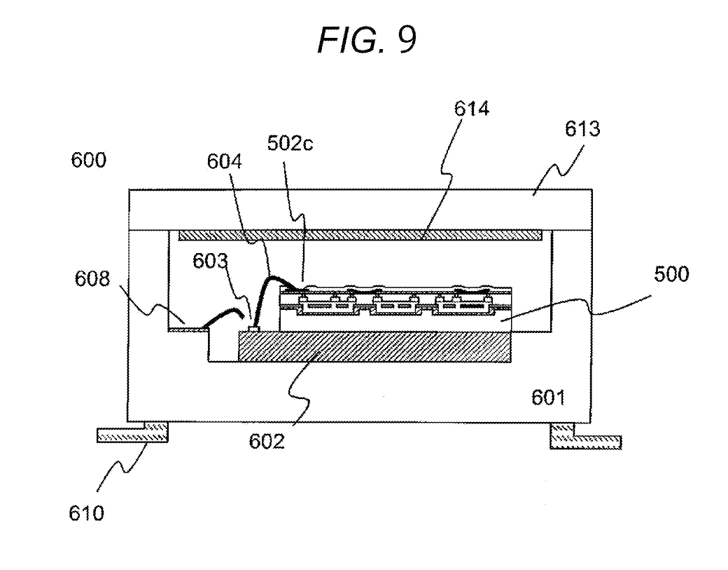

FIG. 9 is a sectional view showing an exemplary mounting configuration of the inertial sensor module 600 in Example 2. FIG. 9 is a sectional view of the inertial sensor module taken along the line D-D′ shown in FIG. 7.

In FIG. 9, the computation circuit chip 602 and the step-up power supply chip which is not shown are mounted on a bottom portion of the package member 601 having a recessed portion. The computation circuit chip 602 and the sensor element 500 are disposed in a layer in the package member 601, and are hermetically enclosed in the package member 601 with a resin cap 613 which is formed of resin such as plastic and hermetically seals the package member 601 at the top portion thereof. A metal shielding plate 614 is formed on the resin cap 613, specifically on a side facing an inner portion of the package. The resin cap 613 is a resinous lid used for hermetically sealing the package member 601 which houses the sensor elements 500, 540, the computation circuit chip 602, and the step-up power supply chip 550. The resin cap 613 serves to prevent the package member 601 from foreign matter contamination.

When the pad group 520 is selected for use to from the pad groups in the sensor element 500 in order to obtain an angular velocity output with respect to a desired detection axis, a pad group 530, provided to detect an angular velocity output in regard to a detection axis which is not applied, is not electrically connected by wiring and left open. Meanwhile the unused pad group 530 is connected to the pad group 520 which is in use in the sensor element, via a metal film and a conductive material provided inside the sensor element. A floating electric charge which exists outside the sensor element could adhere to a pad belonging to the open and unused pad group 530. This could have an adverse effect on a terminal of the in-use pad group 520, appearing as an output noise, through the metal film and the conductive material provided inside the sensor element. However, the sensor element 500 is hermetically enclosed in the package member 601 with the resin cap 613 on which the metal shielding plate 614 is formed. The resin cap 613 hermetically seals the package member 601 at the top portion thereof. Thus the sensor element 500 is protected from effects of a floating electric charge existing outside the sensor module. Therefore, according to Example 2, it is possible to block effects of a noise, even when the unused pad group 530 of the sensor element is not electrically connected with wiring and left open.

As previously described, it is possible to change a rotation angular velocity detection axis of the inertial sensor module 600, by simply changing a mounting direction of the sensor element 500 having an angular velocity detection section, while using exactly the same package member 601, computation circuit chip 602, step-up power supply chip 550, sensor element 540 having an acceleration detection section, and sensor element 500 having the angular velocity detection section. In other words, it is possible to select a rotation angular velocity detection axis as appropriate, by simply changing a mounting direction of the sensor element 500 having the angular velocity detection section, without changing a mounting angle of the inertial sensor module 600.

What has been described heretofore is a variant example of the inertial sensor module which detects an acceleration and includes the LSI 602. In the LSI 602, the sensor element 500 to measure an angular velocity is provided along the first side thereof, and the sensor element 540 to measure an acceleration is provided along the third side opposing the first side. Such composite sensor as above, as with the inertial sensor module set forth in Example 1, attains advantageous effects including an effect of enabling a detection axis to be changed without modifying components other than the sensor element. In addition, as shown in FIGS. 7 and 8, the pad group 603 of the LSI 602 remains situated along a second side of the LSI, even after the two sensor elements are provided. Therefore, the inertial sensor module in the present example, as in the case of Example 1, eliminates a problem caused by placing a pad which is larger in size compared to wiring width at a location other than a corner point of an LSI, which has been cited as a problem in reference to PTL 1. As a result, a reduced chip surface area and reduced development costs will be achieved.

Although an angular velocity sensor element and an acceleration sensor element have been described thus far as examples of sensor elements, a combination of sensor elements is not limited to the aforementioned examples. It is sufficient that such combination includes at least one sensor element having a detection axis.

### REFERENCE SIGNS LIST

100 sensor element
101 cap
102 pad
102a pad
102b pad
103 wiring
104 fixing part
105 movable part
106 detection electrode
107 substrate
108 insulation film
109 insulation film
110 adhesive layer
111 internal space
112 insulation film
120 pad
130 pad
200 sensor module
201 package
202 computation circuit chip
203 pad
204 wiring
205 pad
206 wiring
207 pad
208 terminal
209 lid
500 sensor element
501 substrate through part
502 pad
502a pad
502b pad
503 wiring
504 fixing part
505 movable part
506 detection electrode
507 substrate
508 insulation film
509 insulation film
510 metal film
511 internal space
512 insulation film
513 substrate
514 substrate
520 pad
530 pad
540 sensor element
550 step-up power supply chip
600 sensor module
601 package
602 computation circuit chip
603 pad
604 wiring
605 pad
606 wiring
607 pad
608 pad
609 wiring
610 terminal
613 resin cap
614 metal

1. An inertial sensor module comprising:
a first sensor element having a detection axis, including:
a first pad group; and
a second pad group electrically connected to the first pad group and disposed at a location rotated 90 degrees with respect to the first pad group; and
an LSI configured to control the first sensor element,
wherein the first sensor element is disposed along a first side of the LSI,
the LSI has a plurality of third pad groups disposed along a second side of the LSI, the second side intersecting the first side, and
the third pad group is electrically connected to either the first pad group or the second pad group.

2. The inertial sensor module according to claim 1, further comprising a plurality of wiring lines connecting the first pad group and the second pad group,
wherein the wiring lines are formed on a single conductive layer.

3. The inertial sensor module according to claim 1, further comprising a plurality of wiring lines connecting the first pad group and the second pad group,
wherein the wiring lines are formed of a plurality of conductive materials.

4. The inertial sensor module according to claim 1, wherein a pad arrangement in the first pad group and a pad arrangement in the second pad group are identical.

5. The inertial sensor module according to claim 1,
wherein the first pad group includes a first pair of pads configured to perform a predetermined function in pairs,
the second pad group includes a second pair of pads configured to perform the predetermined function in pairs, and
an arrangement of the first pair of pads in the first pad group and an arrangement of the second pair of pads in the second pad group are identical.

6. The inertial sensor module according to claim 1, wherein a physical quantity measured by the first sensor element is an angular velocity.

7. The inertial sensor module according to claim 6, further comprising a second sensor element configured to detect an acceleration and disposed, in the LSI, along a third side opposing the first side of the LSI.
